(19) United States
(12) Patent Application Publication
(10) Pub. No.: US 2002/0199098 A1
(43) Pub. Date: Dec. 26, 2002

(54) Non-invasive SSL payload processing for IP packet using streaming SSL parsing

(76) Inventor: John M. Davis, Phoenix, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 09/877,473

(22) Filed: Jun. 8, 2001

(51) Int. Cl. H04L 9/00

(52) U.S. Cl. 713/160

(57) ABSTRACT

An SSL proxy receives encrypted packets of information from a computer. The SSL proxy buffers the encrypted packets until all the packets are received. Once all the packets are received, the encrypted portion of each packet is decrypted and the packet is then forwarded to its intended destination.

### FIELD OF THE INVENTION

This invention relates to the field of data transfer in a network environment and more specifically to non-invasive SSL payload processing for IP Packets using streaming SSL parsing.

### BACKGROUND OF THE INVENTION

The Internet, as well as other networking architectures such as local area networks and wide area networks, allows for different types of computers to communicate with each other. This interoperability is achieved through the use of certain Internet protocols, one such being the TCP/IP protocol. IP or Internet Protocol is designed to provide end to end datagram service between networks. An IP datagram, or packet, comprises a header portion and a data portion. The header portion includes information such as the source of the packet and the destination of the packet. The data portion includes the data being transferred from computer to computer. Due to size limitations of the data portion, typically a message sent from computer to computer utilizes several packets. TCP is a protocol that is responsible for verifying the correct delivery of data from client to server. TCP adds support to detect errors or lost data and to trigger retransmission until the data is correctly and completely received.

As the use of the Internet for such purposes as e-commerce increases, so does the need for secure transactions. The most common way to protect data that is transmitted over the Internet is with the secured socket layer (SSL) protocol. The secured socket layer protocol operates above the TCP/IP layer and below application layer protocols such as HTTP. SSL makes use of TCP to provide a viable end-to-end secure service. SSL allows for server authentication. Server authentication involves a user's ability to confirm a server's identity. A client with SSL enabled software is able to check a server's authentication certificate and public I.D. for validity to confirm the identity of the server. SSL also allows for optional client authentication. Client authentication allows a server to authenticate a client's identity. Client authentication is often used in secured banking situations where the bank (the server) needs to insure it is communicating with a customer (client). SSL also allows for a secured connection to exist between a client and a server. The secured connection requires all information sent between a client and server be encrypted by the sending software and decrypted by the receiving software thus providing a high degree of confidentiality.

The SSL protocol includes two subprotocols. These are the SSL record protocol and the SSL handshake protocol. The SSL record protocol defines a format to transmit data. The SSL handshake protocol involves initially setting up the SSL connection to determine certain parameters to be used during the SSL communication. The initial SSL communications in the SSL handshake protocol is used to authenticate the server to the client, allow the client and the server to select what cryptographic algorithm or ciphering to support, optionally authenticate the client to the server, and use public key encryption techniques to generate shared secrets and establish a secured connection.

During the handshake phase, the client first sends a server the client's SSL version number session ID, its cryptographic settings, randomly generated data, and other information a server needs to communicate with the client. The server then sends the client the server's SSL version number, cipher settings, randomly generated data and other information the client needs to communicate with the server. At this time the server sends its authentication certificate and, optionally, requests the client's certificate. In the third step the client will authenticate the server. Then using the data generated to that point, the client creates a premaster secret for the session, encrypts the premaster secret using the server's public key, which is sent with the server certificate, and sends the encrypted premaster secret to the server. The server uses its private key to decrypt the premaster secret and then performs a series of steps on the premaster secret to generate a master secret. The client also performs its own permutations on the premaster secret to generate the master secret. Then the client and server use the master secret to generate session keys that will be the keys used to encrypt and decrypt information exchanged during that SSL session, as well as to verify the integrity of the information sent. After indicating that all further messages will be encrypted, the SSL handshake is finished and the SSL session is begun.

One drawback to the SSL protocol is that it requires a large amount of computation at the web server to receive and decrypt the encrypted text. Also, because the SSL traffic is routed directly to the web server in an encrypted format it makes use of devices such as network monitoring devices possible. To address this problem, SSL proxies have been introduced. An SSL proxy is a device that is deployed on a computer network behind a router on the server side and receives the network traffic. Non-SSL traffic is passed through to the web server. For SSL traffic, the SSL proxy will perform the SSL handshake and initiate the SSL session with the client. The SSL proxy then receives the SSL message records, places them in order, strips out the encrypted message, decrypts the message and forms new packets with new packet headers and packet records. The packets are then output to the web server using a second connection. The disassembly and re-assembly of SSL message into a new packet before sending it on is time consuming, inefficient, and resource intensive. It requires two network connections; one between the client and proxy and a second one between the proxy and the server. What is needed is a more efficient way to process SSL proxy traffic.

### BRIEF DESCRIPTION OF THE DRAWINGS

For a more complete understanding of the present invention and the advantages thereof, reference is made to the following descriptions taken in conjunction with the following figures, in which like reference numerals represent like parts and in which:

FIG. 1 is a schematic diagram of a system for decrypting packets;

FIG. 2 is a flowchart outlining a buffered implantation;

FIG. 3 is a flowchart outlining the streaming embodiment; and

FIG. 4 is a flowchart outlining yet another embodiment.

### DETAILED DESCRIPTION OF THE DRAWINGS

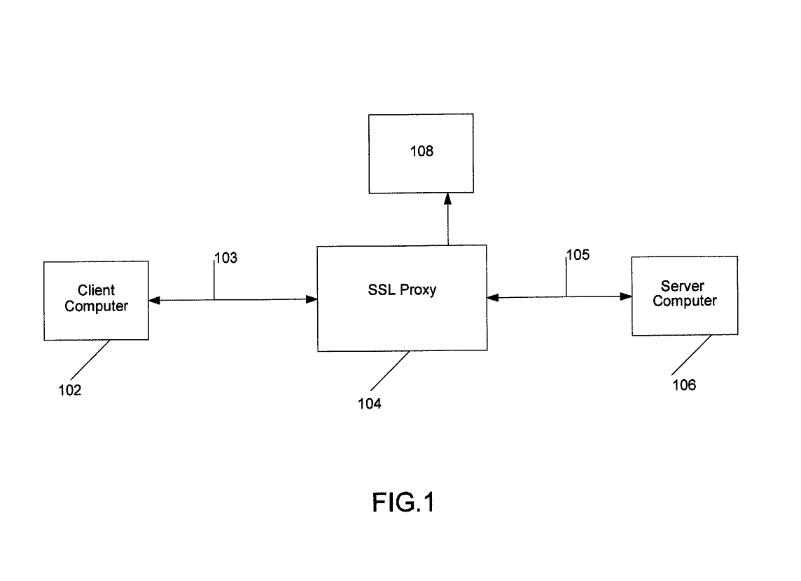

FIG. 1 illustrates a system for streaming SSL traffic. Illustrated is a client computer 102 coupled to a SSL proxy 104 that in turn is coupled to a web server 106. The end-to-end connection between client computer 102 and the web server 106 represents a single TCP connection. This means that packets from the client computer 102 are addressed to the server computer 106 and not the SSL proxy 104. SSL proxy 104 includes a database 108 for storing information concerning the session and the connection. The first communication line 103 between the client computer 102 and SSL proxy 104 is the portion that is the SSL connection with encrypted text. The second communication line 105 between SSL proxy 104 and web server 106 is the portion that is a plain text connection where the text transmitted is unencrypted.

Client computer 102 can be any computer capable of accessing web server 106 such as a personal, home or office computer using a web browsing program capable of supporting SSL, such as Internet Explorer 4.0, by Microsoft, of Redmond Wash. Although only one client computer 102 is shown in FIG. 1, there can be any number of client computers 102 connected to SSL proxy 104. The capacity is limited only by the SSL proxy's ability to handle simultaneous incoming traffic.

SSL proxy 104 is a device that is deployed before the server computer 106 to handle SSL traffic. In one embodiment SSL proxy 104 may be a computer. SSL proxy 104 is operable to receive encrypted packets, hold the packets until all packets are received, decrypt the record fragment in each of the packets, compute the necessary authentication code to verify the authenticity of the message, and forward the record payload in the original packets to the server computer 106. In another embodiment packets could be unencrypted as the packets are received with buffering only used for packets received out of order. SSL proxy 104 includes a database 108 that includes a session table associated with each SSL session. Session table includes the master secret, the SSL transformation information, i.e., the type of coding to be used and the source address and destination address. There is also an optional subtable called a connection table that includes such information as the source and destination port number, the message authentication codes, the initialization vector, the sequence number, the acknowledgement number and other information for the TCP connection.

Web server 106, in one embodiment, is a computer operable to run a web server program and answer and supply information to a client computer 102. Web server 106 receives the unencrypted packets from web proxy 104 and sends unencrypted responses to SSL proxy 104, which encrypts the server traffic enroute to the client 102. Web server 106 may be an actual web server, an application server such as a TCP-based application server, or a virtual construct such as a load balancer, cache appliance, or traffic manager.

In operation, client computer 102 initiates an SSL session with SSL proxy 104. All the initial SSL handshaking will be done between the client computer 102 and the SSL proxy 104. SSL proxy 104 will typically have a copy of the server's authentication certificate already stored. Therefore, all steps necessary for an SSL handshake will be completed and the information necessary to complete the transaction will be stored in database 108.

Upon handshake, certain tables of information are established and stored in database 108. These include the session table and the connection table. The session table tracks a particular client to server communication while a connection is in a particular conversation. There can be many connections under one session. Table I illustrates an example of a session table along with the information tracked, when the information is established and a description of what is being tracked.

| Parameter | Established | Description |
|---|---|---|
| Session ID | At handshake | Unique ID for session |
| Encryption Algorithm | At handshake | Highest encryption |
| | | scheme mutually |
| | | supported |
| MAC Algorithm | At handshake | Highest encryption |
| | | for message |
| | | authentication code |
| Source address | At handshake | IP address of source |
| Destination address | At handshake | IP address of message |
| | | destination |
| Master secret | At handshake | Data used to generate |
| | | master secret |
| Session expiration | At handshake | Sets how long session |
| | | lasts before new one |
| | | needs to be reestablished |
| Client certificate | At handshake | Authentication certificate |
| | | of client to prove client |
| | | identity |

An exemplary connection table is shown as Table II.

| Parameter | Established | Description |
|---|---|---|
| Source port | At connection | Port or computer where |
| | | connection starts |
| Session ID | From session | Unique ID for a session |
| | table | |
| Destination port | From session | Port of destination |
| | table | computer |
| Server key | Calculated at | Servers decryption |
| Server MAC_key | Calculated | Server's key to decrypt |
| | | MAC |
| Client key | Calculated | Clients public key |
| Client MAC_key | Calculated | Clients MAC key |
| Server IV | Calculated | Server Initialization |
| | | Vector |
| Client IV | Calculated | Client Initialization |
| | | Vector |
| Sequence number | Random (from | Current packet number |
| | packet) | |
| ACK number | Random (from | Previous packet number |
| | packet) | |
| Window S2 | Random (from | Number of |
| | packet) | unacknowledged packets |
| MAC state | Random (from | Filled in as MAC |
| | packet) | calculated packet by |
| | | packet |

A third table, the Queue State Table, can also be stored. Table III illustrates an exemplary Queue State Table.

| Parameter | Description |
|---|---|
| Packet Data | Info on packet in queue |
| Q_state | “hold” or “ready” |

After the handshaking is completed and encrypted keys are selected, computer 102 will begin to send encrypted text to SSL proxy 104. SSL proxy 104 will then receive each packet. In a first embodiment, SSL proxy 104 will wait until all packets are received and then, in order, decrypt the record of each packet, verify its authenticity and send it along to server 106. In a second embodiment, SSL proxy 104 will decrypt each packet as received, buffering those packets that are received out of order. After each packet has been decrypted they are then sent to server 106 via second communication line 105. Receipt of the last packet allows authentication to compile. If it passes, the last packet is forwarded; if it fails it is forwarded with a RST flag set (reset), forcing the receiver to discard the record contents. Record size and MAC locations are traced through the gleaning of the record size field in the record header. In the present invention, since packets are not disassembled the proxy need not terminate the TCP session. Thus the source and destination address of a packet from a client does not change. Therefore only a single connection is needed between the client and the server.

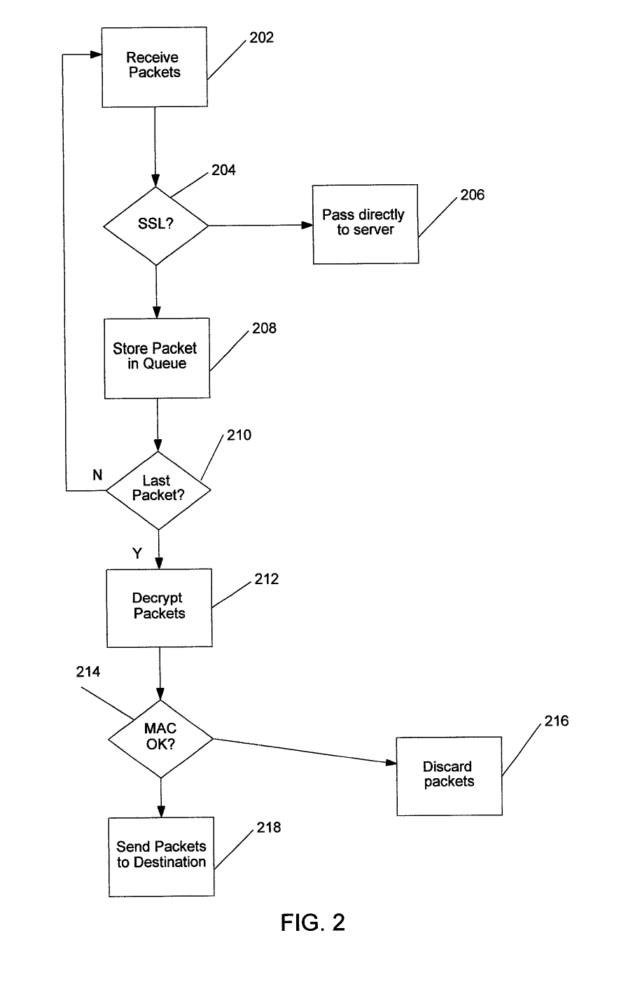

FIG. 2 is a flow chart illustrating the buffered version of the present invention. In step 202, a SSL session is initialized and a packet is received. Then in step 204, the header of the packet is read to determine if it is SSL traffic. If it is not SSL traffic, in step 206 the packet is sent to its destination, typically a web server.

If it is an SSL packet, the packet is held in a hold queue in step 208. In the database 108, the connection table will hold a predetermined value, calculated from the MSS (maximum segment size) or MTU (maximum transmission unit) and the record length in the SSL record header, which indicates how many packets to expect for a give record. This is read from the packet header and is stored in the database 108. In step 210, the queue is checked to see if all the packets have arrived. If not, more packets are received in step 202. Along with checking if the packet sequence is completed, step 210 also tracks the window, another entry in the connection database that tells how many packets can go unacknowledged before the message originator stops sending packets. In step 210, as the number of packets approaches the window count, they may be acknowledged by the proxy.

Once all packets are received, they are outputted, in order, to decryption stage 212, where the record payload is decrypted. In step 214, the message authentication code is checked. If it checks invalid, all packets are discarded in step 216. If they check valid, the decrypted packets are sent to their destination in step 218.

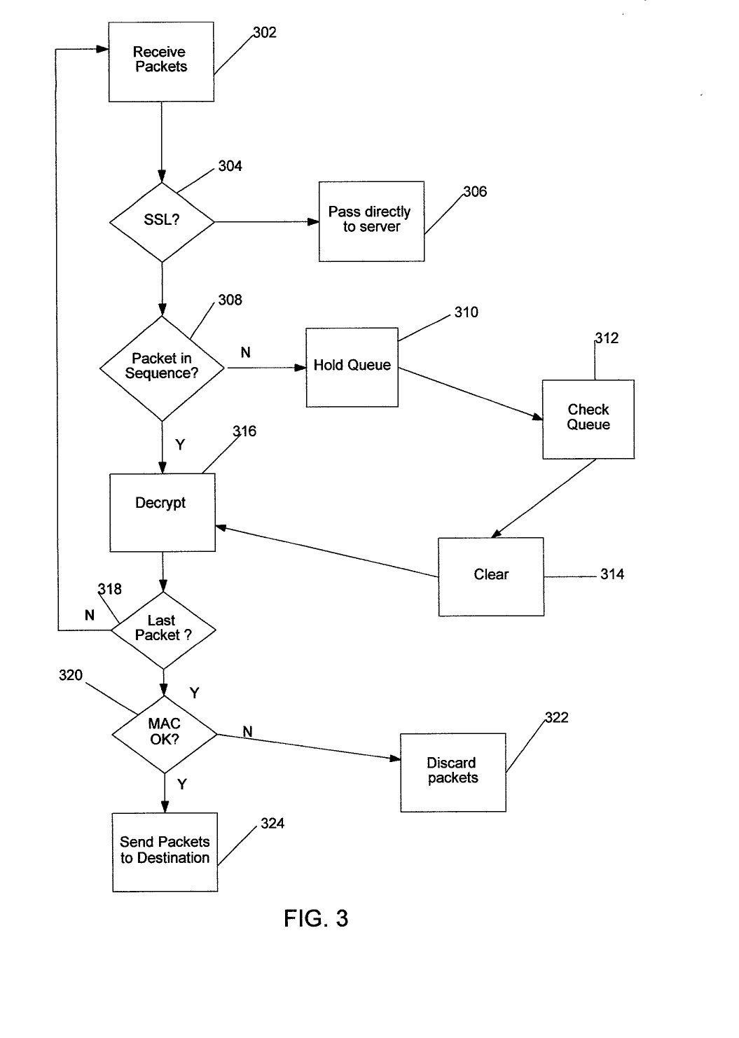

FIG. 3 is a flow chart illustrating an alternative embodiment of the present invention. As before, in step 302, a session is initialized and a packet is received. In step 304, the header of the packet is checked to see if it is SSL traffic. If it is not, in step 306 it is sent to its destination.

If it is SSL traffic, in step 308 it is determined if it is the first packet or if it is the next packet in order. This is done by examining the sequence number in the header of the packet and the connection table. If it is the first or next packet in order, the record of the packet is decrypted in step 316.

If it is not the first or next packet, it is placed in a hold queue in step 310. The hold queue has a controller 312, which checks to see if the subsequent packets received are ones that precede the packet in the hold queue. If all preceding packets to the packet in the queue have arrived, a clear packet signal is given in step 314 and the packet is sent from the hold queue to the decryption step 316. If the packet is not yet ready for release from the hold queue, it stays there until it receives a clear signal.

In step 318, the packets are checked to see if the last packet has arrived. If not, more packets are collected in step 302. If it is the last packet, the message authentication code is verified in step 320. If it is not valid, all packets are discarded in step 322. If the message authentication code is valid, the decrypted packets are sent to their destination.

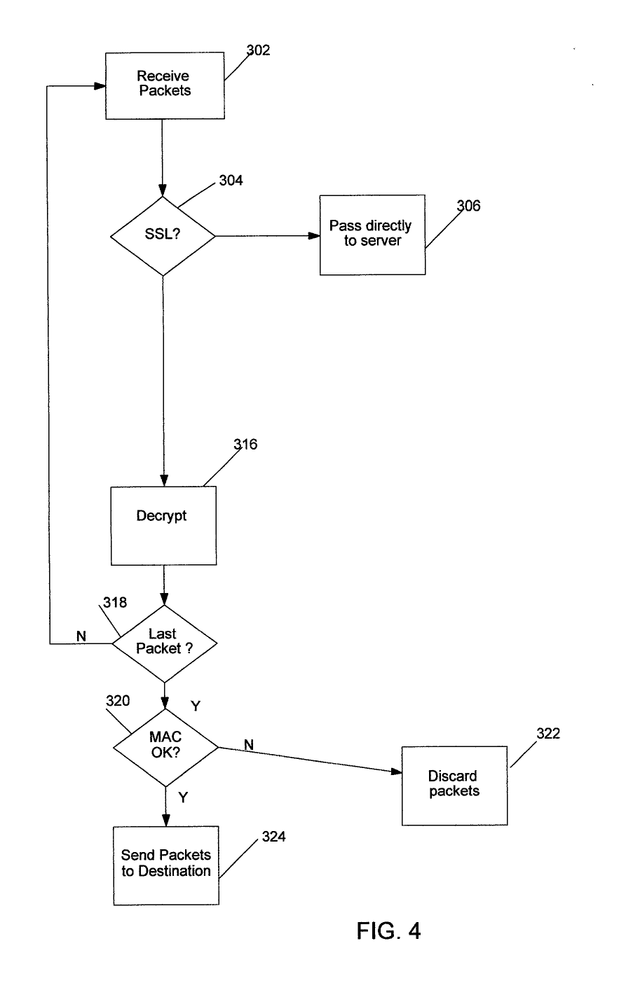

In yet another embodiment, depicted in FIG. 4, the process is performed without explicitly determining whether the packets are received in order. Thus, the hold queue and associated processing steps are omitted from this embodiment. Instead, the packets are processed as received using the MAC check (STEP 320), since the MAC check inherently ensures that the sequencing was correct.

While the invention has been particularly shown and described in the foregoing detailed description, it will be understood by those skilled in the art that various other changes in form and detail may be made without departing from the spirit and scope of the invention.

I claim:

1. An apparatus for handling SSL traffic comprising an SSL proxy operable to receive a plurality of packets each including an encrypted portion, the SSL proxy operable to buffer the packets until a predetermined number of packets are received, the SSL proxy further operable to decrypt the encrypted portion of each received packet and forward the decrypted packets to a predetermined destination.

2. The apparatus of claim 1, wherein the SSL proxy includes a database operable to track information regarding a type of encryption scheme used to encrypt the encrypted portion.

3. The apparatus of claim 1, wherein the encrypted portion of the packets are decrypted when received and the SSL proxy buffers the received packets out of order.

4. The apparatus of claim 1, wherein the SSL proxy tracks a message authentication code used to authenticate a message.

5. The apparatus of claim 1, wherein the packets are sent by a client computer and received by a server computer.

6. The apparatus of claim 5, wherein the SSL proxy is operable to receive unencrypted data from the server computer, encrypt the unencrypted data, and send the encrypted data to a client computer.

7. The apparatus of claim 1, wherein the SSL proxy performs encryption and decryption on packets using a single end-to-end TCP connection between a client computer and a server.

8. A system for handling SSL traffic comprising:
a client computer operable to initiate an SSL session and to send packets with encrypted payloads;
a server computer operable to support communications with the client computer; and
a SSL proxy coupling the client computer and the server computer and operable to decrypt the encrypted payloads of each packet and forward the decrypted packets to the server computer.

9. The system of claim 8, wherein the SSL proxy includes a database operable to track information regarding a type of encryption scheme used to encrypt the encrypted payloads.

10. The system of claim 8, wherein the packets are decrypted when received by the SSL proxy and the SSL proxy buffers the received packets out of order.

11. The apparatus of claim 8, wherein the SSL proxy tracks a message authentication code used to authenticate a message.

12. The system of claim 8, wherein the SSL proxy is operable to encrypt packets sent from the server computer to the client computer.

13. The system of claim 8, wherein a single end-to-end TCP connection exists between the client computer and the server computer.

14. The system of claim 8, wherein the SSL proxy buffers the packets until a predetermined number of packets arrive, then decrypts packets, and forward the decrypted packets to the server.

15. A method for processing SSL packets comprising:
initializing an SSL session between a client computer and a SSL proxy;
receiving a packet including an encrypted portion at the SSL proxy;
determining if the received packet is a SSL packet;
placing the received packet in a hold queue;
checking the hold queue for a complete set of packets;
decrypting the encrypted portion of each packet once the complete set of packets are received; and
outputting the decrypted packets to a server computer.

16. The method of claim 15, wherein a message authentication code is checked to verify authenticity of the packet set.

17. The method of claim 15, wherein non SSL packets are sent directly to the server.

18. The method of claim 15, wherein the step of placing the packets in a hold queue comprises:
placing packets received out of order in a queue;
decrypting packets received in order and forwarding the decrypted packets to a server computer;
checking the hold queue to determine if the packet in the queue is next in sequence;
releasing the packet from the hold queue if the packet in hold queue is the next in sequence; and
getting a new packet if the packet in the hold queue is not the next in sequence.

19. The method of claim 15, wherein the step of initializing further comprises initializing a single end-to-end TCP connection between the client computer and the server computer.

20. The method of claim 15, further comprising:
receiving packets with unencrypted data at a SSL proxy from the server computer;
encrypting the packets at the SSL proxy; and
sending the encrypted packets to the client computer.

21. An apparatus for decrypting network data traffic comprising a proxy operable to:
(i) receive packets addressed to a server computer, the packets including an encrypted portion, a destination address, and a source address;
(ii) decrypt the encrypted portions of the received packets; and
(iii) send the decrypted portions to a server computer without altering the destination or source address of the received packets.

22. The apparatus of claim 21, wherein the proxy is further operable to:
(i) receive packets addressed to a client computer, the packets including an unencrypted portion, a destination address, and a source address;
(ii) encrypt the unencrypted portion of the received packets; and
(iii) send the encrypted packets to the client computer without altering the destination or source address of the packets.
